(19) United States
(12) Patent Application Publication
(10) Pub. No.: US 2016/0243779 A1
(43) Pub. Date: Aug. 25, 2016

(54) BALING APPARATUS

(71) Applicant: AUSTRALIA PRIME FIBRE PTY LTD, Tanawha (AU)

(72) Inventor: Paul WOOSLEY, Brisbane (AU)

(21) Appl. No.: 15/026,531

(22) PCT Filed: Sep. 30, 2014
(86) PCT No.: PCT/AU2014/050260

§ 371 Date: Mar. 31, 2016

(30) Foreign Application Priority Data
Oct. 1, 2013 (AU) 2013903795

(51) Int. Cl. B30B 9/30; B65B 27/12; A01F 15/00

(52) U.S. Cl. CPC B30B 9/3075; A01F 15/00; B30B 9/3078; B30B 9/3014; B65B 27/125

(57) ABSTRACT

A baling apparatus for forming bales of fibrous or fluff material includes a plurality of chambers being movable between a compression location and a discharge location, a compression applicator for applying compression to fibrous or fluff material in a chamber when that chamber is in the compression location and a discharger for discharging a compressed bale of fibrous or fluff material from a chamber when that chamber is in the discharge location. A bale may be compressed whilst another bale is being discharged such that compression and discharge occur in parallel, thereby increasing production.

### TECHNICAL FIELD

The present invention relates to a baling apparatus for forming bales of fibrous or fluff material. The present invention also relates to a method for forming bales of fibrous or fluff material.

### BACKGROUND ART

Fibrous and fluff materials, such as sugarcane mulch, garden mulch, lucerne mulch, pine straw, hay, straw and raw cotton, is frequently packaged, stored, transported and sold in the form of bales. Bales of these products are frequently formed by compressing the product to increase its density, followed by tying or bagging the bale so that the bale retains its shape. It is advantageous to place the fibrous and fluff materials into the form of compressed bales because the compressed bales occupy significantly less volume than the native materials, thereby reducing storage and transport volumes and cost.

A number of a baling machines have been developed over the years in an effort to increase the rate of production of bales of material and reduce the cost of production of those buyouts of material. In most known baling machines, the fibrous or fluff material is fed to a chamber where it is compressed. The bales of compressed material may then be discharged into bags or tied with string, rope or other wrapping materials.

In one baling machine that is used to manufacture bales of sugarcane mulch, the sugarcane mulch is fed to a chamber. Opposed vertical rams move towards each other to vertically compress the sugarcane mulch. A horizontal ram is then extended to horizontally compress the sugarcane mulch. The horizontal ram presses the sugarcane mulch against a closed outlet door and the reaction force caused by the movement of the ram towards the closed outlet door compresses the sugarcane mulch in a horizontal direction. When the desired level of compression has been reached, as is typically ascertained by the sugarcane mulch reaching a desired length or volume, the outlet door is opened. Continued movement of the horizontal ram pushes the compressed bale of sugarcane mulch out of the chamber and into a bagging machine. The compressed bale of sugarcane mulch then passes through a bagging station in which the compressed bale of sugarcane mulch becomes sealed within a bag, typically a heat sealable plastic bag, such as a heat shrink plastic bag. The bagged bale is then removed by a conveyor to a storage area or onto a transport vehicle.

Although known baling machines can successfully produce large numbers of bales of fibrous or fluff material, improvements to the number of bales produced each day and/or reductions in the cost of producing bales are always desirable.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a baling apparatus and to a method for producing bales, which may at least partially overcome at least one of the abovementioned disadvantages or provide the consumer with a useful or commercial choice.

In a first aspect, the present invention provides a baling apparatus for forming bales of fibrous or fluff material, the baling apparatus comprising:

a plurality of chambers being movable between a compression location and a discharge location,

a compression applicator for applying compression to fibrous or fluff material in a chamber when that chamber is in the compression location, and

a discharger for discharging a compressed bale of fibrous or fluff material from a chamber when that chamber is in the discharge location.

In some embodiments, the baling apparatus further comprises a revolver that is rotatable about an axis, the plurality of chambers being formed in or mounted to the revolver.

The plurality of chambers may rotate relative to a base plate. The base plate may be fixedly mounted in the baling apparatus. The base plate may include a plurality of openings, each opening forming an opening to a chamber. The openings may form inlet openings to the chambers when the chambers come into register with the openings. The base plate may be mounted directly upstream of the revolver.

The baling apparatus may further comprise a front wall that is fixed relative to the revolver. The front wall may lie adjacent to a downstream end of the revolver. The front wall may be provided with one or more openings at a discharge location. The openings may define a discharge outlet through which a bale of compressed fibrous or fluff material can be discharged from the chamber when the chamber is in the discharge location.

In another embodiment, the revolver may comprise a plurality of chambers mounted about a common axis. The chambers may be arranged to rotate relative to a fixed rear wall and to rotate relative to a fixed front wall. The chambers may have an open front end and an open rear end. The rear wall may have openings that coincide with the position of the discharge locations and the compression locations. The front wall may have openings that coincide with the discharge locations. The front wall may have a solid wall or a closure at locations that coincide with the compression locations of the chambers.

In some embodiments, the baling apparatus further comprises one or more antechambers located upstream of the compression location. The one or more antechambers may come into register with respective ones of the plurality of chambers when the respective ones of the plurality of chambers move into the compression location. The antechambers may receive fibrous or fluff material from a fibrous or fluff material feeder. The fibrous or fluff material may be subjected to a first compression in the antechamber and then moved into respective ones of the plurality of chambers when they are in the compression location, with further compression being applied to the fibrous or fluff material in the respective ones of the plurality of chambers. The first compression may be applied in a first direction and the further compression may be applied in a direction that is perpendicular to the first direction. The first compression may be applied vertically and the second compression may be applied horizontally. The compression applicator that provides the further compression may act to move the fibrous or fluff material from the antechamber into the chamber.

In one embodiment, the fibrous or fluff material is compressed in a vertical direction in the antechamber and the fibrous or fluff material is moved in a horizontal direction into the respective ones of the plurality of chambers when the respective ones of the plurality of chambers are in the compression location, with horizontal compression being applied to the fibrous or fluff material in the respective ones of the plurality of chambers that are in the compression location. In this embodiment, the baling apparatus may comprise at least one compression applicator for applying compression to the fibrous or fluff material in the one or more antechambers.

The baling apparatus may be provided with bagging apparatus for bagging the bale of fibrous or fluff material that is discharged at the discharge locations. The bale may comprise a bale of compressed fibrous or fluff material and the bagging apparatus may bag the bale of compressed fibrous or fluff material to retain the bale of fibrous or fluff material in a substantially compressed condition. The bagging apparatus may bag the bale of fibrous or fluff material in a plastic bag, such as a heat sealable plastic bag or a heat shrinkable plastic bag. The bagging apparatus may seal the bale of fibrous or fluff material in the bag

The bagging apparatus may comprise a conventional bagging machine.

In other embodiments, the baling apparatus may be provided with a tying apparatus or a wrapping apparatus or a strapping apparatus to tie up, wrap or strap the bale.

The compression applicator may comprise a movable ram that moves into contact with the fibrous or fluff material. Continued movement of the movable ram into contact with the fibrous or fluff material applies a compressive force to the fibrous or fluff material, which acts to compress the fibrous or fluff material.

The baling apparatus may further comprise a feeder for feeding fibrous or fluff material to the plurality of chambers or to the antechambers. In some embodiments, the feeder supplies fibrous or fluff material to the one or more antechambers and the fibrous or fluff material is subsequently moved from the one or more antechambers into respective ones of the plurality of chambers. The feeder may comprise any conventional feeding apparatus that is known to be suitable for feeding fibrous or fluff material. Examples include feed conveyors, feed chutes, feed augurs, screw feeders, or pneumatic conveying feeders.

In embodiments where the baling apparatus is provided with a revolver, the apparatus may further comprise a drive motor for rotating the revolver. The drive motor may comprise an electric motor, an internal combustion engine, a hydraulic motor or a pneumatic motor. The drive motor may rotate the revolver in accordance with control signals that move the chambers of the revolver between the compression location and the discharge location, and vice versa.

In a preferred embodiment of the present invention, the baling apparatus is provided with four chambers. In this embodiment, the baling apparatus may have two compression locations and two discharge locations. Fibrous or fluff material is compressed in the two chambers located at the compression locations and a bale of compressed fibrous or fluff material is discharged from each of the two chambers located at the discharge locations. In this manner, compression and discharge of the bales occur as separate actions, thereby allowing for increased throughput and production of bales. Effectively, the steps of compression and discharge occur in parallel whereas in known baling machines, the steps of compression and discharge occur in series.

In this embodiment, the compression applicators that apply compression to the fibrous or fluff material in the chambers located at the compression locations may comprise movable rams, heads or plates, with each compression applicator being driven from a common driving source. For example, a single hydraulic cylinder may carry separate compression heads that are in alignment with the chambers in the compression locations, whereby extension of the single hydraulic cylinder causes the separate compression heads to extend into their respective chambers and compress the fibrous or fluff material in the chambers. The compression heads may comprise plates or bodies.

Similarly, in some embodiments, the dischargers that discharge the bales of fibrous or fluff material from the chambers located at the discharge locations may comprise movable rams, heads or plates, with each discharger being driven from a common driving source. For example, a single hydraulic cylinder may carry separate discharge heads that are movable into the chambers in the discharge locations, whereby extension of the single hydraulic cylinder causes the separate discharge heads to extend into their respective chambers located in the discharge locations to discharge bales of fibrous or fluff material from the chambers.

In a second embodiment, the present invention provides a baling apparatus for forming bales of fibrous or fluff material, the baling apparatus comprising:

a plurality of chambers being movable between a compression location and a discharge location,

compression means for applying compression to fibrous or fluff material in a chamber when that chamber is in the compression location, and

discharge means for discharging a compressed bale of fibrous or fluff material from a chamber when that chamber is in the discharge location

The present invention also relates to a method for forming a bale of compressed fibrous or fluff material. Accordingly, in a third aspect, the present invention provides a method for forming a bale of compressed fibrous or fluff material comprising feeding fibrous or fluff material to a chamber that is located at a compression location and compressing the fibrous or fluff material in the chamber that is located at the compression location, moving the chamber to a discharge location and discharging a bale of compressed fibrous or fluff material from the discharge location, and returning the chamber to the compression location.

The compression location and the discharge location may be located away from each other.

In a further aspect, the present invention provides a method for forming a bale of compressed fibrous or fluff material in a baling apparatus that includes a plurality of chambers, the method comprising locating one chamber at a compression location, locating another chamber at a discharge location, feeding fibrous or fluff material to a chamber located at the compression location and compressing the fibrous or fluff material in the chamber, discharging a bale of compressed fibrous or fluff material from the other chamber located at the discharge location, and subsequently moving the one chamber from the compression location to the discharge location and moving the other chamber from the discharge location to the compression location.

Suitably, movement of the one chamber from the compression location to the discharge location occurs simultaneously with movement of the other chamber from the discharge location to the compression location.

In some embodiments, the one chamber and the other chamber move between respective compression locations and discharge locations by rotating the chambers about a common axis.

In some embodiments, the method comprises supplying fibrous or fluff material to two chambers, each located at one of two compression locations and compressing the fibrous or fluff material whilst discharging bales of compressed fibrous or fluff material from two chambers each located at one of two discharge locations, moving each of the chambers at the compression locations from the compression locations to the discharge locations whilst moving each of the chambers at the discharge locations from the discharge locations to the compression locations, and supplying and compressing fibrous or fluff materials to the chambers located at the two compression locations whilst discharging bales of compressed fibrous or fluff material from the chambers located at the two discharge locations.

Suitably, discharge of the compressed bales from the two chambers located at the discharge locations occurs at the same time as compression of the fibrous or fluff material in the two chambers located at the compression location. Suitably, movement of the chambers from the discharge locations to the compression locations occurs at the same time as movement of the chambers from the compression locations to the discharge locations.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge,

### BRIEF DESCRIPTION OF DRAWINGS

Various embodiments of the invention will be described with reference to the following drawings, in which:

FIG. 1 shows a perspective view from the front end or discharge end of a baling apparatus in accordance with one embodiment of the present invention;

FIG. 2 shows a front elevation view (or an elevation view looking from the discharge end) of the baling apparatus shown in FIG. 1;

FIG. 3 shows a side elevation view of the baling apparatus shown in FIG. 1;

FIG. 4 shows a rear elevation view (or an elevation view looking from an upstream end or a feed end) of the bailing apparatus shown in FIG. 1;

FIG. 5 shows a perspective view from the front side showing the revolver with its side wall removed so that the internal arrangement of chambers in the revolver can be seen;

FIG. 6 shows a perspective view from the front side showing the feed arrangement for providing fibrous material to the antechambers;

FIG. 7 shows a rear view of the apparatus shown in FIG. 5;

FIG. 9 shows a schematic view of the antechamber and a chamber in register with the antechamber when in the compression location with the vertical presses just starting to compress the mulch in the antechamber; and

FIG. 10 shows a similar schematic view to that shown in FIG. 9, but with the horizontal press having moved the mulch into the chamber and horizontally compressed the mulch in the chamber.

### DESCRIPTION OF EMBODIMENTS

It will be appreciated that the drawings have been provided for the purposes of illustrating preferred embodiments of the present invention. Therefore, the skilled person will understand that the present invention should not be considered to be limited solely to the features as shown in the attached drawings.

Throughout this specification, the terms “upstream” and “downstream” will be used with reference to the movement of fibrous material through the baling apparatus. It will be understood that the fibrous material is supplied to the baling apparatus via a feeder. The fibrous material is then pressed and discharged as a bale of compressed material followed by bagging of the bale. The feeder is upstream of the bagging apparatus and the bagging apparatus is downstream of the feeder. The term “front” will be used to refer to parts of the apparatus that are located towards the discharge end of the apparatus and the term “rear” will be used to refer to parts of the apparatus that are located towards the feed end of the apparatus.

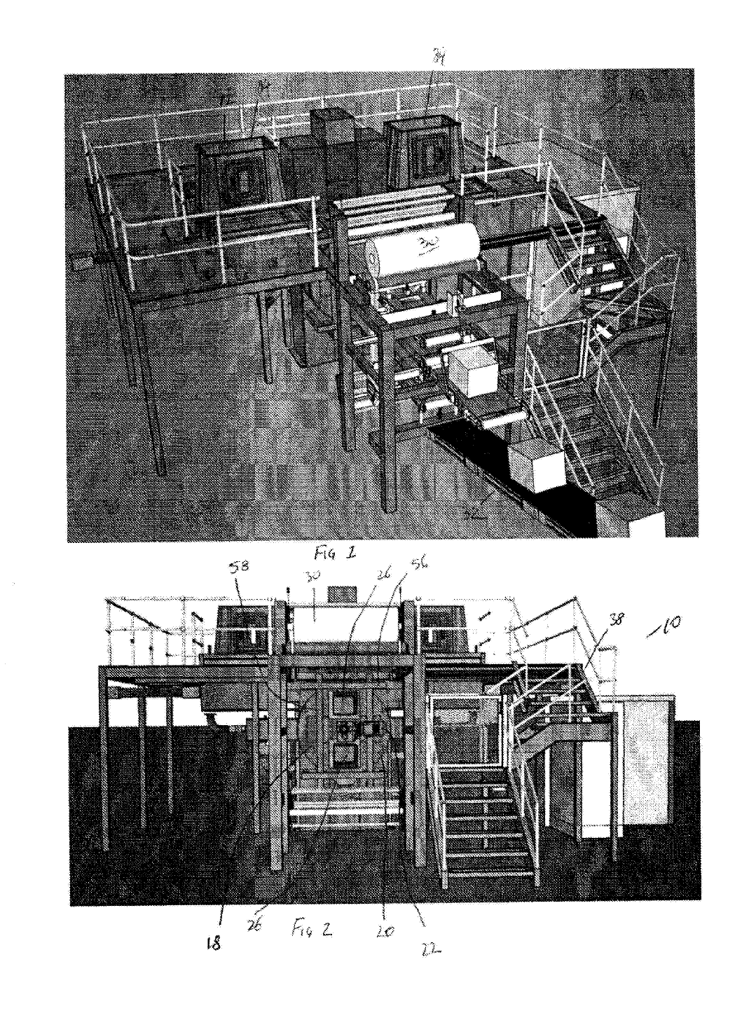

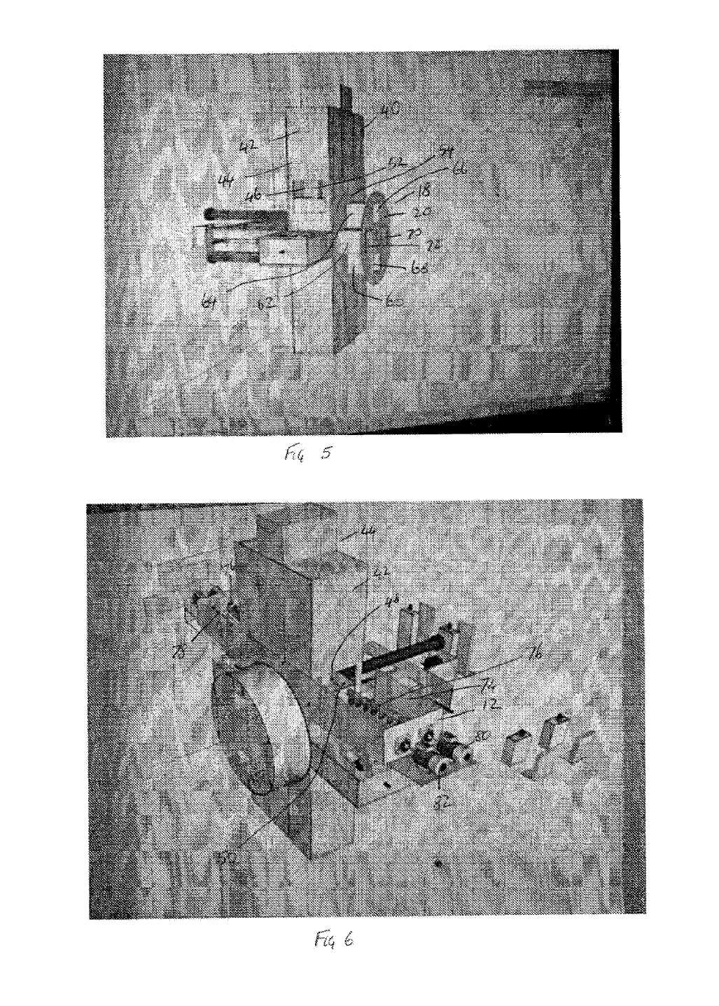

FIGS. 1 to 4 show various views of the baling apparatus 10 in accordance with the present invention. The baling apparatus 10 shown in the attached figures may be used for forming bales of sugarcane mulch. For convenience, the description of the baling apparatus shown in the attached figures will be provided with reference to forming bales of sugarcane mulch. However, it will be appreciated that the apparatus may be used to form bales of any other suitable fibrous or fluff material and the apparatus should not be considered to be limited solely to making bales of sugarcane mulch.

The baling apparatus includes feeders 12 that feed sugarcane mulch from a storage area or hopper to the apparatus. The sugarcane mulch is delivered to 2 separate antechambers, designated generally at 14 (see FIG. 3). The sugarcane mulch in the antechambers 14 is compressed by opposed rams that move towards each other in the vertical direction. Once the rams have compressed the sugarcane mulch to the desired level in the vertical direction, horizontally extendable rams or heads move the sugarcane mulch horizontally. The horizontally extendable rams or heads are mounted to one or more extendable cylinders that are positioned within passageways 16. Passageways 16 may be made as a simple rectangular box that surrounds or encases the cylinders. Passageways 16 minimise the intrusion of dirt and chaff into the extendable cylinders and also provide a safety barrier between operating personnel and the extendable cylinders.

Extension of the horizontally extendable cylinders located in passageways 16 causes the rams or heads of those cylinders to come into contact with the rear surface of the mulch in the antechambers. This forces the mulch into the chambers of the revolver 18 that are in alignment with the antechambers. Those chambers of the revolver are in the compression locations. The baling apparatus has a front wall 20 that is fixed relative to the revolver. The front wall 20 provides a closed front surface to the two chambers that are located in the compression location. Once the sugarcane mulch comes into contact with the front wall of the revolver, continued extension of the horizontally extendable cylinder results in the sugarcane mulch being compressed in a horizontal direction.

Following application of sufficient horizontal compression to the sugarcane mulch, the revolver 18 is caused to rotate by drive motor 22 until the chambers that were located at the compression locations have been moved to the discharge locations. The front wall 20 of the revolver has openings at the discharge locations and the chambers have front ends that come into alignment with the openings in the front wall when the chambers are in the discharge location. Discharge cylinders, which may be positioned inside protective tubes 24, are actuated to extend in the horizontal direction. This pushes the compressed bales of sugarcane material out of the chambers and through discharge ducts 26.

The bales of compressed sugarcane mulch them pass through a bagging region, generally shown at 28 in FIG. 3. The bagging region 28 includes a roll 30 of plastic bags that are used to bag the bales of sugarcane mulch. Another roll of plastic bags (not shown in FIG. 3) is used to bag the bales discharge from the lower discharge duct. The bagged bales then drop onto a conveyor 32, which transports the bales of sugarcane mulch to a storage area or to transport vehicle.

The baling apparatus 10 is constructed using appropriate framework to support or mount the various components. The construction of this framework is essentially conventional and only minimal description of the framework will be provided hereunder. A gantry 34 having safety rails 36 and access stairs 38 is provided so that operating personnel can have easy access to the higher parts of the apparatus.

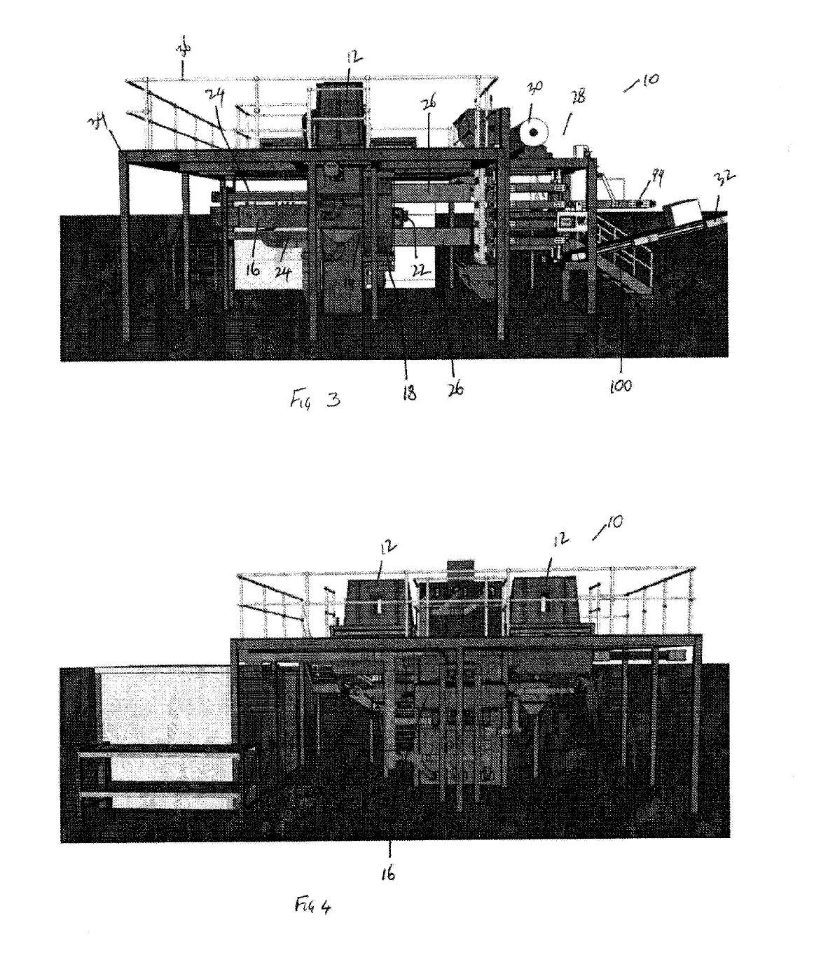

In FIG. 1, details of the lower bagging station have been omitted for clarity. In FIG. 2, the bagging stations and the discharge conveyor have been omitted for clarity.

FIGS. 5 to 10 show various views of features of the baling apparatus 10 shown in FIGS. 1 to 4, but with surrounding detail omitted or various walls or metal sheets that enclose those features being omitted so that further detail of those features can be seen.

FIG. 5 shows a view of the section of the baling apparatus 10 that includes the revolver 18 and the section of the apparatus that includes the antechambers. In FIG. 5, a framework 40 is used to provide support to metal cover sheets 42 and other components of the bagging apparatus 10. The framework 40 may be manufactured from steel components that are bolted together or welded together

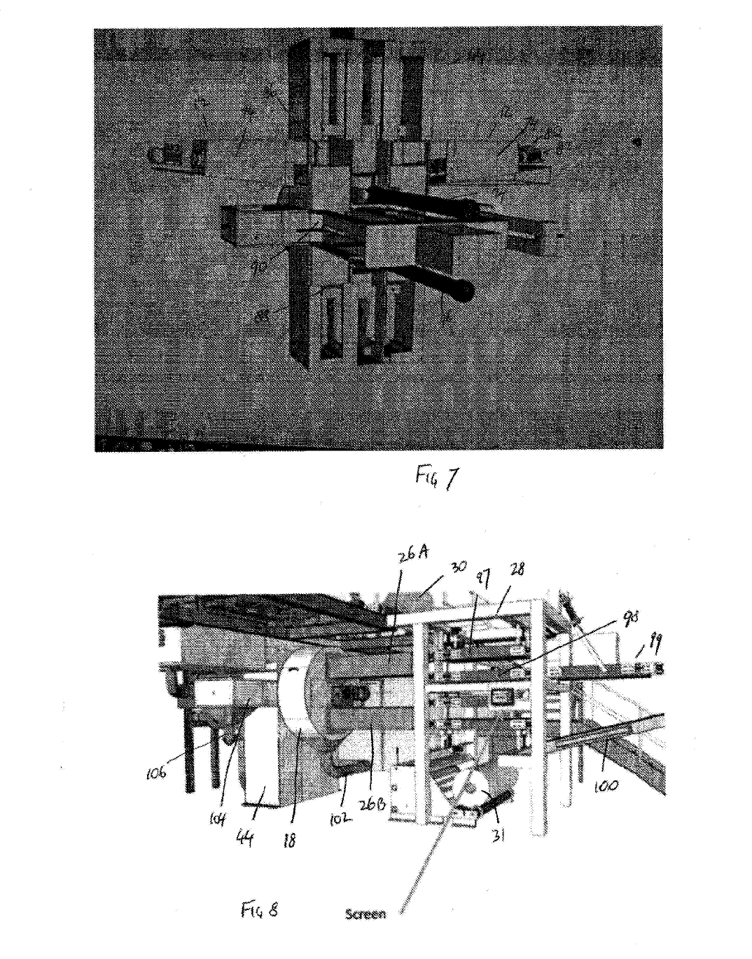

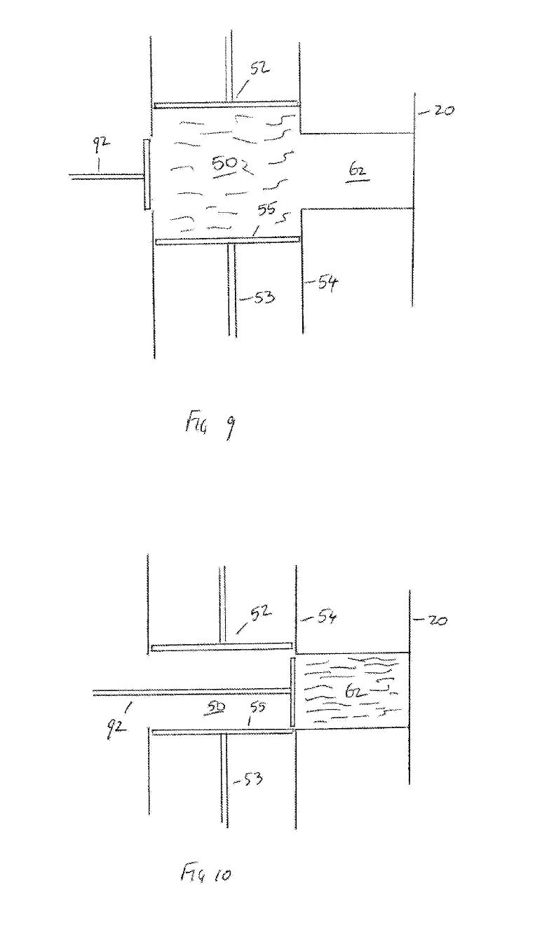

The apparatus shown in FIG. 5 includes a central core 44. The side walls of the central core 44 include openings 46, 48. Openings 46, 48 lead into open vertical passageways that are positioned above the antechambers. One of the antechambers 50 can just be seen in FIG. 6. As can be seen in FIG. 5, a vertical press 52 is located in the passageway above the antechambers. In some embodiments, a similar vertical press 53 is located below the antechamber, with the head of that vertical press 55 effectively forming the floor of the antechamber 50 (see FIGS. 9 and 10). In other embodiments, the floor of the antechamber is fixed.

The baling apparatus 10 also includes four chambers. Three of these chambers are shown in FIG. 5 at reference numerals 60, 62, 64. As can also be seen in FIG. 5, the front wall 20 includes opening 66, 68. The opening 66, 68 are positioned at the discharge locations. The front wall also includes closures 70, 72. The closures 70, 72 are positioned at the compression locations. It will be appreciated that if the front wall is fabricated such that solid metal is not removed from beneath the closures 70, 72, it may not be necessary to provide separate closures 70, 72. However, providing closures 70, 72 does al low for the possibility of removing those closures to facilitate maintenance or to facilitate clearance of blockages within the apparatus. It will be understood that, in this embodiment, the front wall 20 is fabricated by forming a sheet of metal to the desired size and shape, removing four sections from the sheet of metal to form four openings and covering two of those openings with closures 70, 72.

It will be appreciated that the revolver 18 has four chambers equally spaced around the central axis of the revolver 18. The chambers are basically located at 90° to each other. Each chamber may comprise spaced side walls, a top wall and a bottom wall.

Although not shown, it will also be understood that the base plate 54 has openings formed therein that correspond to the rear of each of the chambers. This allows the sugarcane mulch to be moved into the chambers that are located in the compression locations. This also allows the discharge cylinders to extend into the chambers that are located at the discharge locations to discharge the bales of compressed sugarcane mulch from the chambers.

The four chambers are each mounted equidistantly around a central frame, axle or body. The four chambers have an open front wall and an open rear wall. The base plate or rear wall 54 is fixed to the central core 44 and the front wall 20 is fixedly mounted to the framework members 56, 58. The four chambers are able to be rotated by the drive motor 22, which causes the four chambers to rotate relative to both the front wall 20 and the base plate/rear wall 54. Appropriate seals or low friction surfaces may be provided between the ends of the chambers and the surfaces of the base plate and the front wall of the revolver 18 that abut the respective ends of the chambers. This embodiment is desirable in that as the chambers revolve, the two chambers that have bales of compressed sugarcane mulch in them are presented with the closed surfaces of the front wall and base plate of the revolver as they move from the compression location to the discharge location. This assist in maintaining the shape of the bale during the rotation step. A stationary side wall may extend around the chambers to provide a safety guide to protect personnel from the rotational movement of the chambers.

The feeders 12 comprise an open topped duct or vessel 74 that houses two screw augurs 76, 78. Drive motors 80, 82 drive the screw augurs. Weighing chambers 84 are positioned above the open topped ducts 74. Loose sugarcane mulch or native sugarcane mulch is supplied through the weighing chambers 84 into the open topped ducts 74. A predetermined weighed amount of sugarcane mulch is provided from the weighing chamber to the duct 74. At this stage, the drive motors 80, 82 are operated to cause the augurs 76, 78 to move the sugarcane mulch from the feeders 12 into the antechambers.

As best shown in FIG. 8, the central core 44 includes an upper vertical press 86 and a lower vertical press 88 that can move vertically towards and away from antechamber 90. The head or end of lower vertical press 88 forms the floor of antechamber 90. Once sugarcane mulch has been supplied to antechamber 90, the upper vertical press 86 and lower vertical press 88 are actuated such that they extend and move relatively towards each other which causes the vertical compression of the sugarcane mulch in the antechamber 90 (see FIG. 9). Once the desired level of compression has been applied by the vertical press 86, 88 (which will typically be determined by limit switches or other sensors that detect when the vertical presses 86, 88 have reached a desired maximum extension), a horizontal press 92 which is located within passageway 16 is extended such that its end or head comes into contact with the sugarcane mulch. This causes the sugarcane mulch to move into chamber 63 which is positioned behind closure 70 in the orientation shown in FIG. 5. The sugarcane mulch continues to move forward into chamber 63 until it comes into contact with the closure 70. Continued extension of the horizontal press 92 compresses the sugarcane mulch against the closure 70, thereby reducing the volume and increasing the density of the sugarcane mulch. This step is shown in FIG. 10.

When the end of the horizontal press 92 reaches the front end of the antechamber 90, the sugarcane mulch has been compressed to its desired extent. Control signals actuated the drive motor 22 to cause the revolver 18 to rotate the chambers by 90°. As a result, the chamber 62, 63 that were located at the compression locations rotate and move until the front ends of the chamber 62, 63 come into alignment or register with the openings 66, 68 in the front wall 20 of revolver 18. At this location, the chambers 62, 63 are positioned in the discharge location.

The baling apparatus 10 is also provided with two dischargers 94, 96. Dischargers 94, 96 are in the form of extendable arms that move horizontally. The ends of the dischargers contact the compressed bale of sugarcane mulch and push the compressed bale of sugarcane mulch out of the respective chambers 62, 63 and along discharge ducts 26. The discharge ducts 26 are sized and shaped such that the bale of compressed sugarcane mulch retains its shape as it moves along the discharge ducts 26.

When the bale of compressed sugarcane mulch exits the front end of discharge ducts 26, they enter the bagging region 28. As can be seen from FIG. 9, the discharge ducts 26 comprise an upper duct 26A and a lower duct 26B that is vertically spaced from upper duct 26A. As the bales are being discharged along both discharge ducts 26A, 26B, two bales are being simultaneously discharged. Therefore, it is desirable to provide two separate bagging stations. The bagging stations are of conventional construction and will only be described in limited detail.

The upper bagging station that receives bales of sugarcane mulch from upper duct 26A is provided with plastic bags from roll 30. The lower baking station which receives bales of sugarcane mulch from lower discharge duct 26B is provided with plastic bags from roll 31. The front end of discharge duct 26A discharges bales of compressed sugarcane mulch between automatically adjusting upper and lower conveyors, which maintain pressure on the bales. The plastic bags are fed from the roll 30 and are automatically opened, such as by a blast of air. The bags are positioned such that the bales enter into the bags. The bales may enter the bags just as they exit the discharge ducts 26A, 26B. In this manner, the extending horizontal presses that move the bales along the discharge ducts also push the bales into the plastic bags. The bags are then heat sealed to close the openings. Further heat may be applied to cause the bags to heat shrink around the bales. The bales then move on to respective upper conveyor 99 and lower conveyor 100. The lower conveyor 100 merges into discharge conveyor 32. Bales from the upper conveyor 99 drop onto the discharge conveyor 32.

In the apparatus shown in the attached drawings, loose sugarcane mulch is supplied to the two chambers of the revolver that are positioned at the compression locations. Operation of the presses causes the sugarcane mulch to be compressed into the desired bale in the chambers of the revolver that are positioned at the compression location. At the same time, bales of compressed sugarcane mulch are being discharged from the chambers of the revolver that are positioned at the discharge locations. Thus, formation of two bales by compressing sugarcane mulch is occurring at the same time as discharge of two other bales of compressed sugarcane mulch is occurring. As a result, the actions of forming a bale and discharging another bale take place at the same time. Thus, formation of the bale and discharge of the bale occur in parallel, rather than in series as is the case with existing baling apparatus. This results in a significant increase in production of bales.

Further increases in production occur by virtue of bales being formed simultaneously in two separate chambers of the revolver whilst two bales are simultaneously being discharged from two other chambers of the revolver.

As a further advantage, as the chambers are being rotated from the compression location to the discharge location, the antechambers can be filled with loose mulch and vertical compression applied. When the empty chambers move into register with the compression locations, the horizontal presses can be actuated to move the vertically compressed mulch into the chambers for completion of horizontal compression. This also assists in improving the rate of production of bales.

In some embodiments of the present invention, the horizontal presses that compress the bales in the chambers positioned at the compression locations are operated by a single cylinder. In this regard, it will be appreciated that a single extendable cylinder can have two arms attached to it such that extension of the single cylinder causes both arms to extend horizontally to move compressed sugarcane mulch in the chambers positioned at the compression locations. In this manner, only a single stroke of a cylinder may be required to horizontally compress two bales. As production expenses increase with each extension of the cylinder, using a single cylinder extension to compressed two bales provides apparent economic benefits to the production process.

Similarly, the two discharge presses may also be operated from a single cylinder.

The apparatus of the present invention may also be provided with appropriate ventilation and dust and chaff removal systems. For example, the revolver 18 may be provided with a dust removal flue/pipe 102 that is connected to a fan or a source of vacuum. Dust removal from the antechambers may occur via side passages 104 and dust removal flue/pipe 106 (see FIG. 8).

Preferred embodiments of the present invention may provide the following advantages:

Use of the revolving chambers allows two bales to be made at the same time as two bales are being ejected or discharged from the apparatus.

A single hydraulic cylinder may be used to compress fibres of the material in two compression chambers.

The bales may be compressed from opposite sides, which allows you to make different sized bales as well as providing short stroke lengths on the cylinders to greatly increase the speed of the baling apparatus.

Dual weighing chambers may provide dual weighed doses of material to chambers underneath them so there is always raw material ready to send into the compression chambers to minimise or avoid the need to stop the system.

The apparatus of the present invention may be controlled using known to control technology, such as PLC controllers with graphic operator guidance. The apparatus can be designed to have minimal floor space requirements and to have easy access to individual machine components. Appropriate selection of materials and construction can provide for long service life.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A baling apparatus for forming bales of fibrous or fluff material, the baling apparatus comprising:
a plurality of chambers being movable between a plurality of compression locations and a plurality of discharge locations;
antechambers associated with each compression location, the antechambers located upstream of the compression locations, wherein the antechambers come into register with respective ones of the plurality of chambers when the respective ones of the plurality of chambers move into the compression locations;
a feeder for feeding fibrous or fluff material to the plurality of chambers or to the antechambers;
a first compression applicator for applying a first compression in a first direction to the fibrous or fluff material in the antechamber, the first compression applicator being operable to apply the first compression whilst a chamber is moving from a discharge location to a compression location;
a second compression applicator for applying compression in a second direction generally perpendicular to the first direction to the fibrous or fluff material to move the fibrous or fluff material into a chamber and to compress the fibrous or fluff material in the chamber when that chamber is in a compression location; and
a discharger for discharging a compressed bale of fibrous or fluff material from a chamber when that chamber is in a discharge location.

2. The baling apparatus as claimed in claim 1 further comprising a revolver that is rotatable about an axis, the plurality of chambers being formed in or mounted to the revolver.

3. The baling apparatus as claimed in claim 1 wherein the plurality of chambers rotate relative to a base plate, the base plate being fixedly mounted in the baling apparatus, the base plate include a plurality of openings, each opening forming an opening to a chamber.

4. The baling apparatus as claimed in claim 3 wherein the openings form inlet openings to the chambers when the chambers come into register with the openings.

5. The baling apparatus as claimed in claim 2 further comprising a front wall that is fixed relative to the revolver, the front wall being provided with one or more openings at a discharge location, the openings defining a discharge outlet through which a bale of compressed fibrous or fluff material is discharged from the chamber when the chamber is in the discharge location.

6. The baling apparatus as claimed in claim 2 wherein the revolver comprises a plurality of chambers mounted about a common axis, the chambers being arranged to rotate relative to a fixed rear wall and to rotate relative to a fixed front wall, the chambers having an open front end and an open rear end, the rear wall having openings that coincide with the position of the discharge locations and the compression locations, the front wall having openings that coincide with the discharge locations, the front wall having a solid wall or a closure at locations that coincide with the compression locations of the chambers.

7. The baling apparatus as claimed in claim 1 further comprising bagging apparatus for bagging the bale of fibrous or fluff material that is discharged at the discharge locations or the baling apparatus is provided with a tying apparatus or a wrapping apparatus or a strapping apparatus to tie up, wrap or strap the bale.

8. The baling apparatus as claimed in claim 1 wherein the second compression applicator comprises a movable ram that moves into contact with the fibrous or fluff material.

9. The baling apparatus as claimed in claim 2 further comprising a drive motor for rotating the revolver.

10. The baling apparatus as claimed in claim 1 wherein the baling apparatus is provided with four chambers and the baling apparatus has two compression locations and two discharge locations with fibrous or fluff material being compressed in the two chambers located at the compression locations and a bale of compressed fibrous or fluff material is discharged from each of the two chambers located at the discharge locations.

11. The baling apparatus as claimed in claim 1 comprising a plurality of compression applicators and a plurality of dischargers.

12. The baling apparatus as claimed in claim 11 wherein the dischargers that discharge the bales of fibrous or fluff material from the chambers located at the discharge locations comprise movable rams, heads or plates, with each discharger being driven from a common driving source.

13. A method for forming a bale of compressed fibrous or fluff material comprising feeding fibrous or fluff material to an antechamber, applying a first compression in a first direction to the fibrous or fluff material in the antechamber, applying a second compression in a second direction that is generally perpendicular to the first direction when a chamber comes into register with a compression location, the second compression causing the fibrous or fluff material to move from the antechamber into the chamber and to be compressed in the second direction, moving the chamber to a discharge location whilst the chamber is being moved to the discharge location feeding fibrous of fluff material to the antechamber and applying the first compression to the fibrous of fluff material in the antechamber, discharging a bale of compressed fibrous or fluff material from the discharge location, and returning the chamber to the compression location.

14. The method as claimed in claim 13 wherein a plurality of chambers are movable between two or more compression locations and two or more discharge locations and a plurality of antechambers are provided, each antechamber being associated with a compression location.

15. The method as claimed in claim 14 wherein movement of the one chamber from the compression location to the discharge location occurs simultaneously with movement of the other chamber from the discharge location to the compression location.

16. The method as claimed in claim 14 wherein the one chamber and the other chamber move between respective compression locations and discharge locations by rotating the chambers about a common axis.
